(19) United States
(12) Patent Application Publication
(10) Pub. No.: US 2014/0102416 A1
(43) Pub. Date: Apr. 17, 2014

(54) FUEL MANAGEMENT SYSTEM

(71) Applicant: CATERPILLAR INC., Peoria, IL (US)

(72) Inventors: Arvind Sivasubramanian, Peoria, IL (US); Venkat Vijay Kishore Turlapati, Peoria, IL (US)

(73) Assignee: Caterpillar Inc., Peoria, IL (US)

(21) Appl. No.: 13/649,133

(22) Filed: Oct. 11, 2012

(51) Int. Cl. F02D 41/30; F02D 41/26

(52) U.S. Cl. 123/458

(57) ABSTRACT

A fuel management system for an engine having a common fuel rail. The fuel management system includes means to regulate air supply and fuel supply. A control unit is provided to determine a maximum allowable fuel mass flow supplied from the fuel rail, based on the air supply and a predetermined air-fuel ratio for the operating parameters of the engine. The control unit calculates an allowable upper limit of rail pressure based on the determined maximum allowable fuel mass flow. The control unit regulates the fuel supply based on the determined allowable upper limit of the rail pressure.

### TECHNICAL FIELD

The present disclosure relates to a fuel management system and, in particular to a fuel management system for an engine which utilizes a fuel rail for fuel supply.

### BACKGROUND

Engines employing a fuel rail to deliver fuel to the combustion chambers via the associated fuel valves are widely known in the art. The fuel rail may receive a pressurized supply of fuel from a fuel source. In such engines, the amount of fuel supplied from the fuel rail may depend on a fuel rail pressure value, which in turn is based on the required air-fuel ratio, determined on the basis of the operating parameters of the engine.

In a typical engine, there may be a risk of detonation of fuel in combustion chambers in case the amount of the fuel supplied exceeds a certain value for the given operating parameters of the engine. Conventionally, to limit the risk of detonation, a fuel supply system includes means to determine a maximum allowable mass flow rate of the fuel based on the requisite air-fuel ratio, which in turn is determined on the basis of the operating parameters of the engine. Further, the fuel supply system may measure an actual mass flow rate value of the fuel supplied to the combustion chamber. The injection system may, then, check the actual flow rate value against the maximum allowable flow rate value, and determine the risk of detonation based on the comparison, and if required take preemptive steps to avoid the same.

U.S. Pat. No. 5,967,119 discloses a fuel pressure control system for an electromechanical fuel injection system. The fuel injection system includes a fuel rail for receiving pressurized fuel from a fuel source and operable to supply pressurized fuel to an injector. The fuel rail pressure control system includes a pressure regulator having a flexible diaphragm separating a reference pressure chamber and a fuel chamber. The fuel chamber is in fluid communication with the fuel rail at a fuel inlet and in fluid communication with a fuel return line at a fuel outlet. A variable valve component, disposed in a bypass line, operates to vary fuel pressure in the reference pressure chamber to thereby proportionately vary pressure in the fuel chamber and the fuel rail.

### SUMMARY

In one aspect, the present disclosure provides a fuel management system for an engine having a common fuel rail leading to a plurality of fuel lines associated with combustion chambers of the engine. The fuel management system includes a choke valve configured to regulate an air supply based on a pre-determined air-fuel ratio, where the air-fuel ratio is calculated on the basis of one or more operating parameters of the engine. A fuel valve is provided to supply a pressurized fuel from a fuel source to the fuel rail, and a fuel admission valve is provided to regulate the delivery of the fuel from the fuel rail to the combustion chamber, via the fuel line. A control unit is provided to determine maximum allowable fuel mass flow from the fuel rail to the combustion chambers. The control unit also calculates an allowable upper limit of rail pressure based on the determined maximum allowable fuel mass flow. The control unit further regulates the fuel supply based on the determined allowable upper limit of the rail pressure.

In another aspect, the present disclosure provides a method of supplying fuel in an engine in which fuel is delivered by a common fuel rail to combustion chambers, via a plurality of fuel lines. The method includes determining a maximum allowable fuel mass flow from the fuel rail to the combustion chambers based on the air supply and the air-fuel ratio. The method, then, includes calculating an allowable upper limit of rail pressure based on the determined maximum allowable fuel mass flow. Further, the method includes regulating the fuel supply based on the determined allowable upper limit of the rail pressure.

Other features and aspects of this disclosure will be apparent from the following description and the accompanying drawings.

### BRIEF DESCRIPTION OF THE DRAWINGS

FIG. 1 illustrates a schematic representation of an exemplary disclosed engine, according to an aspect of the present disclosure;

FIG. 2 illustrates a schematic control diagram of a fuel management system for the engine, according to an aspect of the present disclosure; and

FIG. 3 illustrates a process flow chart depicting exemplary steps performed to regulate the fuel supply in the engine, according to an aspect of the present disclosure.

### DETAILED DESCRIPTION

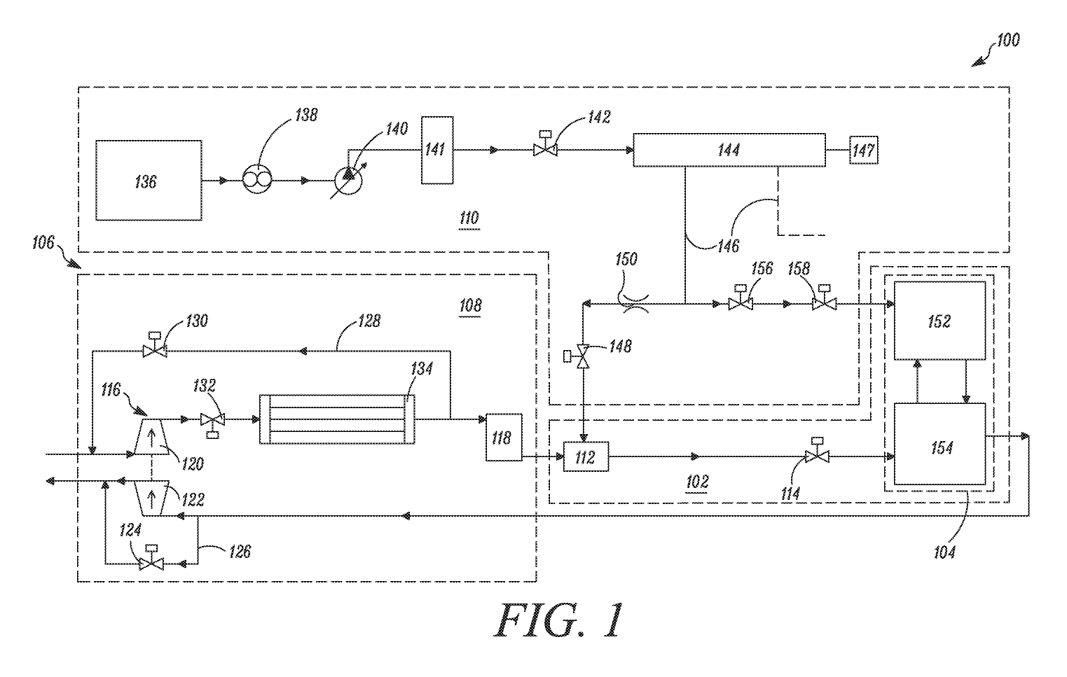

The present disclosure will now be described in detail with reference being made to accompanying figures. FIG. 1 illustrates a schematic representation of an engine 100 in accordance with an embodiment of the present disclosure. The embodiments described herein have been explained in terms of a gaseous engine. It may be contemplated that the described embodiments may be implemented with any type of spark-ignited engine such as a gasoline engine, a natural gas engine, a petrol engine, or an engine using gaseous hydrocarbon fuels like propane, methane, etc.

The engine 100 may include one or more cylinders 102 made of some metallic compounds like steel, aluminum, etc. In the illustrated embodiment, the engine 100 has been described in conjunction with only one cylinder as the reference. Each of the cylinders 102 may include a piston (not illustrated), which is adapted to reciprocate therein. The piston may define a combustion chamber 104 which receives an air-fuel mixture within the cylinder 102 for combustion. The combustion of the air-fuel mixture in the combustion chamber 104 causes the release of pressurized exhaust gases, which in turn pushes the piston to provide the motive force.

The engine 100 of the present disclosure includes a fuel management system 106 which controls the supply of air and fuel in the engine 100. As illustrated in FIG. 1, the fuel management system 106 primarily includes an air supply unit 108 and a fuel supply unit 110 which regulates the supply of air and fuel, respectively. The air supply unit 108 and the fuel supply unit 110 works in conjunction to provide an air-fuel mixture to be supplied to the combustion chamber 104.

In an embodiment, the cylinder 102 may include an inlet port 112 connected to the air supply unit 108 and the fuel supply unit 110. The air and fuel supplies from the, respective, air supply unit 108 and fuel supply unit 110 may be mixed at the inlet port 112, and the resultant air-fuel mixture is passed to the combustion chamber 104. Further, the cylinder 100 may include an inlet valve 114 which regulates the admission of the air-fuel mixture from the inlet port 112 into the combustion chamber 104, in the engine 100.

In an exemplary embodiment of the present disclosure, the air supply unit 108 may include a turbocharger 116 to provide compressed air to an air inlet manifold 118. In particular, ambient air is drawn into a compressor 120 of the turbocharger 116. The turbocharger 116 may also include a turbine 122 connected to receive exhaust gases from the combustion chamber 104, in the engine 100. Further, a wastegate valve 124 may control the exhaust gases mass flow through a turbine bypass line 126, and therefore indirectly control the exhaust gases mass flow through the turbine 122.

The wastegate valve 124 is the means by which air pressure within the air inlet manifold 118 may be controlled when pressurized air is needed. When it is desired to raise air pressure to the engine 100, the wastegate valve 124 may be moved toward a closed position so that substantially more exhaust passes through the turbine 122 instead of through the wastegate valve 124. By controlling the speed of the turbine 122 via the wastegate valve 124, the speed of the compressor 120 may likewise be controlled and also the corresponding air pressure in the air supply unit 108. In an embodiment, the air supply unit 108 further includes a bypass line 128 having a bypass valve 130 to remove the excess air being supplied to the air inlet manifold 118.

The pressurized air from the turbocharger 116 is regulated via a choke valve 132, in the air supply unit 108. The choke valve 132 may be electronically controlled, but is normally maintained fully open except when it is necessary to create a vacuum in the air inlet manifold 118, like under low idle and no load conditions. Air leaving the choke valve 132 may be passed through an after-cooler 134 before being allowed to enter the air inlet manifold 118.

FIG. 1 further illustrates a combined schematic and block diagram of the fuel supply unit 110, according to an embodiment of the present disclosure. The fuel supply unit 110 may be configured to supply fuel for combustion in the combustion chamber 104. The fuel supply unit 110 may include a low pressure fuel source 136, for example, engine fuel tank, to store the fuel. The fuel from the fuel source 136 may be transferred via a low pressure pump 138, such as a gear pump, to a high pressure pump 140, where the fuel is pressurized for further use. The fuel supply unit 110 may also include a venturi 141 to measure a mass flow rate M1 of the fuel therethrough. Further, a fuel valve 142 may be provided to regulate the supply of the pressurized fuel for use in the combustion chamber 104.

In an embodiment of the present disclosure, the fuel may first be accumulated in a fuel rail 144, with a mass flow rate M2, before being supplied to the combustion chamber 104. The fuel supply through the fuel rail 144 may depend on a rail pressure P within the fuel rail 144. A pressure sensor 147 may be associated with the fuel rail 144 to measure the rail pressure P, constantly varying with change in the operating parameters of the engine 100. As known in the art, the fuel rail 144 is basically a line/pipe with a plurality of fuel lines 146 associated therein. For the purpose of illustration, the fuel rail 144 has been shown with two fuel lines 146, out of which the one connected to the reference cylinder 104 is shown in solid lines. Each of the fuel line 146 is in fluid communication with the common fuel rail 144 to receive a pressurized supply of the fuel, and provide a fuel quantity based on the current air supply to achieve a pre-determined air-fuel ratio.

Further, in an embodiment, the fuel supply unit 110 may include a fuel admission valve 148 to regulate the delivery of the fuel from the fuel rail 144 to the combustion chamber 104. The fuel admission valve 148 may be of a type known in the art which controls the fuel mass flow to the combustion chamber 104, and also helps to maintain a pressure differential between the air inlet manifold 118 and the fuel rail 144 to facilitate a proper mixture of the air and the fuel in the inlet port 112. An orifice 150 may also be provided to measure a fuel mass flow rate M3 therethrough.

In an embodiment, each cylinder 102 may be divided into a pre-combustion chamber 152 and a main-combustion chamber 154. The fuel supply unit 110 may provide the pre-combustion chamber 152 with a relatively small amount of the pure gaseous fuel at a lower pressure, while the main-combustion chamber 154 receives a mixture of gaseous fuel and the compressed air. As may be understood that the ignition of the fuel takes place in the pre-combustion chamber 152. A needle valve 156, which may be manually set, may be provided to serve as a means to control the fuel pressure supplied, and a check valve 158 may be provided to regulate the fuel supply to the pre-combustion chamber 152.

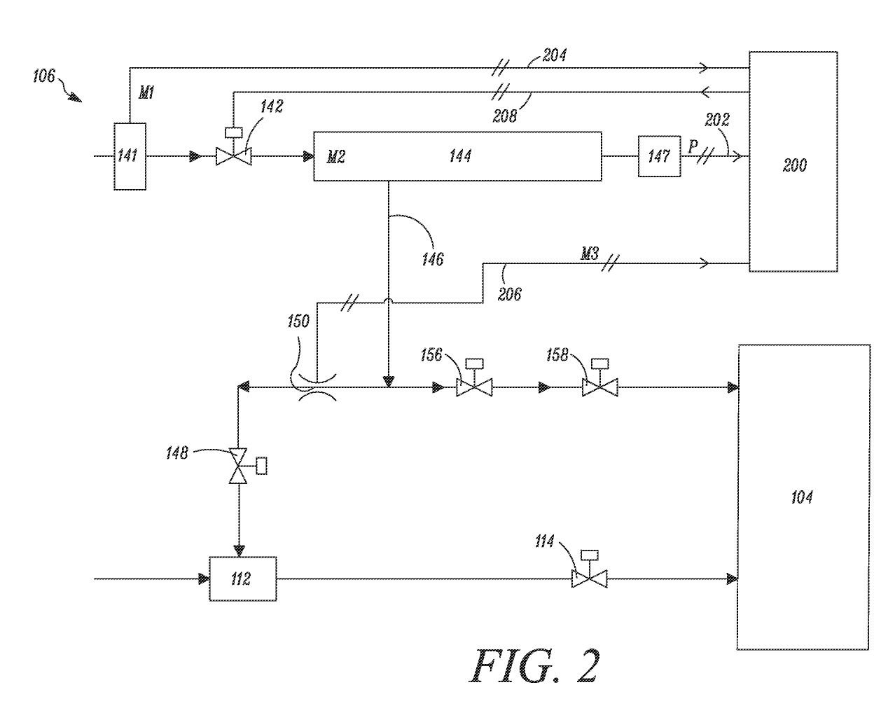

Referring now to FIG. 2, the fuel management system 106 may include a control unit 200 to control the fuel supply by the fuel rail 144, in accordance with an embodiment of the present disclosure. The control unit 200 may be a combination of, for example, but not limited to, a set of instructions, a Random Access Memory (RAM), a Read Only Memory (ROM), flash memory, a data structure, and the like. The control unit 200 may form a part of an Engine Control Unit (ECU), not shown in the accompanied figures, responsible for overall control of the engine 100, such as determining an air-fuel ratio for the given operating parameters of the engine 100. As illustrated in FIG. 2, the control unit 200 may be in communication with some components of the fuel management system 106 by means of a plurality of signal lines.

In an embodiment, the control unit 200 may be configured to control the rail pressure P, and therefore the fuel provided by the fuel line 146 in response to varying operating parameters of the engine 100, such as engine speed, load, etc. For this purpose, the control unit 200 may be in communication with pressure sensor 147, associated with the fuel rail 144, by means of a pressure sensor line 202. The control unit 200 may receive the rail pressure reading P via the pressure sensor line 202. Alternatively, a delta pressure sensor may be used to calculate the rail pressure reading P based on a pressure differential between the fuel rail 144 and the air inlet manifold 118. Further, the control unit 200 may receive the fuel mass flow rate M1 through the venturi 141, via a venturi line 204. The control unit 200 may also receive the fuel mass flow rate M3 from the orifice 150, via an orifice line 206.

In order to regulate the fuel supply through the fuel rail 144, the control unit 200 may control the fuel valve 142 via a fuel valve line 208. In addition, the control unit 200 may further control the high pressure pump 140, in the fuel supply unit 110. Thus, the control unit 200 may precisely control the rail pressure P in the fuel rail 144 and the supply of fuel therefrom.

### INDUSTRIAL APPLICABILITY

The industrial applicability of the apparatus described herein will be readily appreciated from the foregoing discussion. In a typical engine, there may be a risk of detonation in case the mass flow rate of the fuel supplied exceeds a maximum allowable fuel mass flow rate value, for any given operating parameters of the engine. Conventionally, the engine includes flow limiting devices to limit the fuel mass flow rate below this maximum allowable value, and thereby check the threat of detonation. However, such technique may not be the most effective method to pre-empt and avoid the detonation for an engine using a fuel rail.

The fuel management system 106 of the present disclosure employs a method using an upper limit of the rail pressure Pₘₐₓ to avoid the risk of detonation therein. The fuel mass flow rate M3 supplied from the fuel rail 144 to the combustion chamber 104, via the orifice 150, may depend on the rail pressure P. Further, the rail pressure P may be dependent on the current air-fuel ratio, already known by means of lookup tables in the engine control unit (ECU) for the varying operating parameters of the engine 100. Therefore, it may be understood by a person ordinarily skilled in the art that the upper limit of the rail pressure Pₘₐₓ may be proportional to the maximum allowable limit of the fuel mass flow rate M3ₘₐₓ through the orifice 150, for the lowermost/richest allowable air-fuel ratio corresponding to the given operating parameters of the engine 100.

To calculate the upper limit of the rail pressure Pₘₐₓ, the control unit 200 may determine the maximum allowable fuel mass flow rate M3ₘₐₓ by measuring the air supplied, and dividing it by the lowermost/richest allowable air-fuel ratio. Further when the engine 100 is running under conditions with M3 equal to M3ₘₐₓ, measured by the orifice 150, the control unit 200 may measure the fuel mass flow rate M1 introduced in the fuel rail 144 by means of the venturi 141. It is known in the art that for transient condition of the engine 100, the fuel mass flow M1 coming in the fuel rail 144 is equal to sum of the fuel mass flow M3ₘₐₓ going out from the fuel rail 144 and the fuel mass flow M2ₘₐₓ in the fuel rail 144. This way, the fuel mass flow M2ₘₐₓ stored in the fuel rail 144 may be calculated, and thus the corresponding upper limit of the rail pressure Pₘₐₓ may be determined using the pressure equations for the fuel rail 144 in a conventional manner.

In order to minimize the risk of detonation, the control unit 200 checks that the rail pressure P may not exceed the calculated upper limit of the rail pressure Pₘₐₓ. For this purpose, the control unit 200 may regulate the fuel valve 142 to decrease the fuel supply to the fuel rail 144, so as to limit the rail pressure P. In addition, the control unit 200 may further control the high pressure pump 140 to precisely control the rail pressure P in the fuel rail 144 and the supply of fuel therefrom.

Therefore, it may be understood that the fuel management system 106 of the present disclosure may dynamically calculate the upper limit of the rail pressure Pₘₐₓ for the varying operating parameters of the engine 100. The fuel management system 106 further take measures to dynamically limit the rail pressure P to not to exceed the upper limit of the rail pressure Pₘₐₓ. Thus, the fuel management system 106 controls the fuel supply for all operating parameters of the engine 100, and hence dynamically minimizes the risk of detonation.

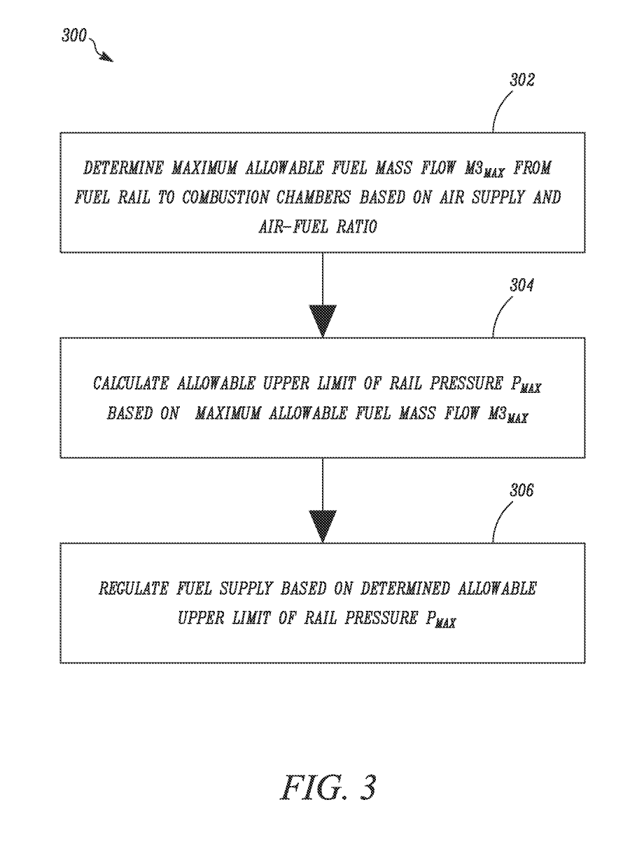

Referring to FIG. 3, a process flow chart 300 is illustrated depicting the steps involved in supplying of fuel in the engine 100, in accordance with the present disclosure. As illustrated, in step 302, the method includes determining a maximum allowable fuel mass flow M3ₘₐₓ from the fuel rail 144 to the combustion chambers 104, based on the air supply and the air-fuel ratio. The determination of the maximum allowable fuel mass flow includes substantially equating, or specifically dividing the air supplied and the lowermost/richest allowable air-fuel ratio, corresponding to the operating parameters of the engine 100.

In step 304, the method includes calculating an allowable upper limit of the rail pressure Pₘₐₓ based on the determined maximum allowable fuel mass flow M3ₘₐₓ as described above. This may involve using pressure equations of the fuel rail 144 correlating the fuel mass flow M2 in the fuel rail 114 to the corresponding rail pressure P. Alternatively, the allowable upper limit of rail pressure Pₘₐₓ may be determined by using module maps having tables correlating the values of maximum allowable fuel mass flow M3ₘₐₓ to the corresponding allowable upper limit of the rail pressure Pₘₐₓ.

Finally, in step 306, the method includes regulating the fuel supply based on the determined allowable upper limit of the rail pressure Pₘₐₓ. Regulating the fuel supply may involve comparing the measured rail pressure P and the calculated allowable upper limit of the rail pressure Pₘₐₓ using some arithmetic logic and/or adder circuits in the control unit 200. The control unit 200 may check if the measured rail pressure P exceeds the allowable upper limit of the rail pressure Pₘₐₓ. In such a condition, the control unit 200 may regulate the fuel supply by adjusting the fuel mass flow rate M1 supplied to the fuel rail 144 via the fuel valve 142.

Although the embodiments of this disclosure as described herein may be incorporated without departing from the scope of the following claims, it will be apparent to a person skilled in the art that various modifications and variations to the above disclosure may be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A fuel management system for an engine having a fuel rail leading to a plurality of fuel lines associated with combustion chambers of the engine, the fuel management system comprising:
a choke valve configured to regulate air supply to the combustion chambers;
a fuel valve configured to regulate fuel supply from a fuel source to the fuel rail;
a fuel admission valve configured to regulate the delivery of the fuel from the fuel rail to the combustion chamber, via the fuel line; and
a control unit configured to:
determine a maximum allowable fuel mass flow from the fuel rail to the combustion chamber by substantially equating the air supply and a pre-determined air-fuel ratio, the air-fuel ratio being determined on the basis of one or more operating parameters of the engine,
calculate an allowable upper limit of rail pressure based on the determined maximum allowable fuel mass flow from the fuel rail, and
regulate the fuel supply based on the determined allowable upper limit of the rail pressure.

2. The fuel management system of claim 1 further including an orifice configured to measure the fuel mass flow from the fuel rail to the combustion chamber.

3. The fuel management system of claim 1, wherein the control unit is configured to determine the maximum allowable fuel mass flow from the fuel rail to the combustion chamber by substantially equating the air supply and the pre-determined richest allowable air-fuel ratio, for given operating parameters of the engine.

4. The fuel management system of claim 1 further including a pressure sensor to measure a rail pressure in the fuel rail.

5. The fuel management system of claim 4, wherein the control unit is configured to regulate the fuel supply in case the measured rail pressure exceeds the calculated allowable upper limit of the rail pressure.

6. The fuel management system of claim 5, wherein the control unit is configured to regulate the fuel supply by adjusting the fuel mass flow rate supplied to the fuel rail through the fuel valve.

7. An engine comprising:
a fuel source;
one or more combustion chambers for combustion of fuel therein;
a fuel rail configured to deliver fuel from the fuel source to the combustion chambers via a plurality of fuel lines associated therewith;
a choke valve configured to regulate air supply to the combustion chambers;
a fuel valve configured to regulate fuel supply from a fuel source to the fuel rail;
a fuel admission valve configured to regulate the delivery of the fuel from the fuel rail to the combustion chamber, via the fuel line; and
a control unit configured to:
determine a maximum allowable fuel mass flow from the fuel rail to the combustion chamber by substantially equating the air supply and a pre-determined air-fuel ratio, the air-fuel ratio being determined on the basis of one or more operating parameters of the engine,
calculate an allowable upper limit of rail pressure based on the determined maximum allowable fuel mass flow from the fuel rail, and
regulate the fuel supply based on the determined allowable upper limit of the rail pressure.

8. The engine of claim 7 further including an orifice configured to measure the fuel mass flow from the fuel rail to the combustion chamber.

9. The engine of claim 7, wherein the control unit is configured to determine the maximum allowable fuel mass flow from the fuel rail to the combustion chamber by substantially equating the air supply and the pre-determined richest allowable air-fuel ratio for the given operating parameters of the engine.

10. The engine of claim 7 further including a pressure sensor to measure a rail pressure in the fuel rail.

11. The engine of claim 10, wherein the control unit is configured to regulate the fuel supply in case the measured rail pressure exceeds the calculated allowable upper limit of the rail pressure.

12. The engine of claim 11, wherein the control unit is configured to regulate the fuel supply by adjusting the fuel mass flow rate supplied to the fuel rail through the fuel valve.

13. A method of managing fuel supply in an engine in which fuel is delivered by a common fuel rail to combustion chambers, via a plurality of fuel lines, the method comprises:
determining a maximum allowable fuel mass flow from the fuel rail to the combustion chambers by substantially equating air supply, in the engine, and a pre-determined air-fuel ratio, the air-fuel ratio being determined on the basis of one or more operating parameters of the engine;
calculating an allowable upper limit of rail pressure based on the determined maximum allowable fuel mass flow from the fuel rail; and
regulating the fuel supply based on the determined allowable upper limit of the rail pressure.

14. The method of claim 13, further including measuring the fuel mass flow from the fuel rail to the combustion chamber.

15. The method of claim 13, wherein determining the maximum allowable fuel mass flow includes substantially equating the air supply and the pre-determined richest allowable air-fuel ratio for the given operating parameters of the engine.

16. The method of claim 13, wherein calculating the allowable upper limit of rail pressure includes correlating a fuel mass flow in the fuel rail.

17. The method of claim 13, wherein regulating the fuel supply includes measuring a rail pressure in the fuel rail.

18. The method of claim 17, wherein regulating the fuel supply includes comparing the measured rail pressure exceeds the calculated allowable upper limit of the rail pressure.

19. The method of claim 18, wherein regulating the fuel supply in case the measured rail pressure exceeds the calculated allowable upper limit of the rail pressure.

20. The method of claim 19, wherein regulating the fuel supply includes adjusting the fuel mass flow rate supplied to the fuel rail.
